(19) United States
(12) Patent Application Publication
(10) Pub. No.: US 2010/0312541 A1
(43) Pub. Date: Dec. 9, 2010

(54) PROGRAM TEST DEVICE AND PROGRAM

(75) Inventor: Masaru Nishimura, Miyagi (JP)

Correspondence Address: PEARNE & GORDON LLP, 1801 EAST 9TH STREET, SUITE 1200, CLEVELAND, OH, 44114-3108, US

(73) Assignee: TOKYO ELECTRON LIMITED, Tokyo (JP)

(21) Appl. No.: 12/864,686

(22) PCT Filed: Jan. 23, 2009
(86) PCT No.: PCT/JP2009/051035

§ 371 Date: Jul. 27, 2010

(30) Foreign Application Priority Data
Jan. 28, 2008 (JP) 2008-015916

(51) Int. Cl. G06F 13/10

(52) U.S. Cl. 703/21

(57) ABSTRACT

A program test device includes a test information receiving unit that receives test information including an operation pattern and input information to be sent to the test target program so as to test the test target program; a test control unit that acquires the operation pattern included in the test information and sends the acquired operation pattern to a simulator program; and an executing unit that sends the input information included in the test information to the test target program and executes the test target program, and also executes the simulator program by using program information as an execution result of the test target program and the operation pattern sent to the simulator program by the test control unit. Therefore, it is easy to test automatically the test target program even in case of a hardware error.

### TECHNICAL FIELD

The present invention relates to a program test device that tests a program for controlling hardware of a semiconductor manufacturing apparatus.

### BACKGROUND ART

As a conventional program test device, there has been a program development device capable of automatically performing a test of a program repetitively (see, for example, Patent Document 1). This device is operated as follows. That is, if a test command is inputted to an automatic test device, the automatic test device asks a state monitoring device whether an emulation device is capable of receiving the command from the automatic test device. If the command is receivable, the command is transmitted to the emulation device. The emulation device executes a test program in response to the received command and transmits the execution result to the automatic test device. The automatic test device stores the execution result and repetitively performs the above-described process for all commands, thereby testing the test program.

Patent Document 1: Japanese Patent Laid-open Publication No. 2003-22199 (see, e.g., page 1 and FIG. 1).

### DISCLOSURE OF THE INVENTION

### Problems to Be Solved by the Invention

In the conventional program test device, however, when a test is performed in case of an abnormal response or an operation failure other than a normal response, the test has been typically performed after changing an operation mode of a simulator to a manual mode. Accordingly, since a manual operation is involved in the test in case of the abnormal response or the operation failure, the test may become complicated and a test error may be caused.

### Means for Solving the Problems

In accordance with a first present invention, there is provided a program test device including: a test target program storage unit that stores therein a test target program; a simulator program storage unit that stores therein a simulator program for simulating an operation of hardware and for performing an operation based on an operation pattern and program information sent from the test target program; a test information receiving unit that receives test information including the operation pattern and input information to be sent to the test target program so as to test the test target program; a test control unit that acquires the operation pattern included in the test information and sends the acquired operation pattern to the simulator program; and an executing unit that sends the input information included in the test information to the test target program and executes the test target program, and also executes the simulator program by using the program information as an execution result of the test target program and the operation pattern sent to the simulator program by the test control unit.

With this configuration, it is possible to perform a test while automatically changing the operation pattern of the simulator program. Thus, a test of a test target program can be automatically performed even in case of a hardware error.

Further, in accordance with a program test device of a second present invention, in the first present invention, the program test device may further include a test information storage unit that stores therein two or more test information; and an automatic test unit that reads out two or more test information from the test information storage unit in sequence and sends the test information to the test information receiving unit.

With this configuration, two or more test items can be automatically tested.

Furthermore, in accordance with a program test device of a third present invention, in the second present invention, the test information may include correct answer information indicating a normal operation result of the test target program. The program test device may further include a test result determination unit that acquires an operation result of the test target program executed by the executing unit, determines normality or abnormality by using the acquired operation result and the correct answer information included in the test information, and outputs a determination result.

With this configuration, normality/abnormality of a test result can be automatically determined.

Further, in accordance with a program test device of a forth present invention, in any one of the first to third present invention, the test information may include an IO value to be used for an operation of the simulator program. The test control unit may acquire the operation pattern and the IO value included in the test information and may send the acquired operation pattern and the IO value to the simulator program. The executing unit may send the input information included in the test information to the test target program and may execute the test target program, and may also execute the simulator program by using the program information as an execution result of the test target program as well as the operation pattern and the IO value sent to the simulator program by the test control unit.

With this configuration, it is possible to perform a test while automatically changing the operation pattern of the simulator program and automatically changing the IO value used by the simulator program. Thus, a test of a test target program can be automatically performed even in case of a hardware error.

Further, in accordance with a program test device of a fifth present invention, in any one of the first to third present invention, the test control unit may perform a process of acquiring the IO value as an operation result of the simulator program and outputting the IO value.

With this configuration, the operation result of the test target program can be accurately checked or determined.

Further, in accordance with a program test device of a sixth present invention, in any one of the first to fifth present invention, the operation pattern may include at least a normal pattern and an abnormal pattern.

With this configuration, tests of at least the normal pattern and the abnormal pattern can be automatically carried out.

In accordance with a seventh present invention, there is provided a program test device including: a test target program storage unit that stores therein a test target program for controlling hardware; a simulator program storage unit that stores therein a simulator program for simulating a hardware error operation; a test information receiving unit that receives test information including an operation pattern and input information to be sent to the test target program so as to test the test target program; a test control unit that acquires the operation pattern included in the test information; and an executing unit that sends the input information included in the test information to the test target program and executes the test target program, sends program information as an execution result of the test target program to the hardware to thereby operate the hardware if the operation pattern acquired by the test control unit is a normal pattern, and executes the simulator program by using the program information as the execution result of the test target program if the operation pattern acquired by the test control unit is not a normal pattern.

With this configuration, even for a test target program operated on the hardware on which it is difficult to generate an error state, tests of a normal case and an abnormal case can be both carried out.

Further, in accordance with a program test device of an eighth present invention, in the seventh present invention, the program test device may further include a test information storage unit that stores therein two or more test information; and an automatic test unit that reads out two or more test information from the test information storage unit in sequence and sends the test information to the test information receiving unit.

With this configuration, two or more test items can be automatically tested.

Furthermore, in accordance with a program test device of a ninth present invention, in the eighth present invention, the test information may include correct answer information indicating a normal operation result of the test target program. The program test device may further include a test result determination unit that acquires an operation result of the test target program executed by the executing unit, determines normality or abnormality by using the acquired operation result and the correct answer information included in the test information, and outputs a determination result.

With this configuration, normality/abnormality of a test result can be automatically determined.

### EFFECT OF THE INVENTION

In accordance with the program test device of the present invention, a test can be successfully performed for a test target program even in case of a hardware error.

### BEST MODE FOR CARRYING OUT THE INVENTION

Hereinafter, embodiments of a program test device will be described with reference to the accompanying drawings. In the following embodiments, parts assigned same reference numerals are operated in the same manner, and redundant description thereof may be omitted.

### First Embodiment

In the first embodiment, a program test device that performs a test of software operating on hardware will be described.

FIG. 1 is a block diagram of the program test device in accordance with the first embodiment.

The program test device 1 includes a receiving unit 11, a test target program storage unit 12, a simulator program storage unit 13, a test information storage unit 14, an automatic test unit 15, a test information receiving unit 16, a test control unit 17, an executing unit 18, and a test result determination unit 19.

The receiving unit 11 receives an input from a user. The input received by the receiving unit 11 may be, e.g., various instructions including a test start instruction for instructing a start of a test or an input of information (e.g., an operation pattern or an IO value) necessary for the test. An input means for inputting the various instructions or the like may include a numeric keypad, a keyboard, a mouse, a menu screen or the like. The receiving unit 11 may be implemented by, e.g., a device driver of the input means such as the numeric keypad or the keyboard, or by control software of the menu screen.

The test target program storage unit 12 stores therein a test target program to be tested. Typically, the test target program is a control program for hardware. For example, the test target program is a control program for hardware such as a semiconductor manufacturing apparatus or a FPD manufacturing apparatus. Although the test target program storage unit 12 is desirably a non-volatile storage medium, it may also be implemented by a volatile storage medium. Here, a process of storing the test target program in the test target program storage unit 12 is not specifically restricted. For example, the test target program may be stored in the test target program storage unit 12 via a storage medium, or the test target program may be transmitted through a communication line or the like and stored in the test target program storage unit 12. Alternatively, the test target program may be inputted through an input device and stored in the test target program storage unit 12.

The simulator program storage unit 13 stores therein a simulator program. The simulator program is a program for simulating an operation of the hardware. Typically, the simulator program is a program for performing an operation based on program information transmitted from the test target program and an operation pattern. The program information is data (information) to be transmitted to the hardware controlled by the test target program. The operation pattern refers to an operation pattern of the hardware. The operation pattern includes at least a normal pattern and an abnormal pattern. The abnormal pattern may include two or more patterns such as a non-response pattern of making no response, an alarm pattern of generating an alarm and a halfway normal pattern showing an abnormal operation after a normal operation is shown halfway. Further, the simulator program may be, e.g., software called stub to be used in a test. The simulator program may perform a process of writing an IO value as an operation result of the simulator program. The simulator program may include a plurality of programs having, e.g., the same function name or method name. The plurality of programs may include, e.g., a program for performing an operation corresponding to the normal pattern and a program for performing an operation corresponding to the abnormal pattern. The IO value is information (data) stored in a certain area of the hardware and the IO value is changed or read out as the test target program is operated. Although the simulator program storage unit 13 may be desirably a non-volatile storage medium, it may also be implemented by a volatile storage medium. Here, a process of storing the simulator program in the simulator program storage unit 13 is not specifically restricted. For example, the simulator program may be stored in the simulator program storage unit 13 via a storage medium, or the simulator program may be transmitted through a communication line or the like and stored in the simulator program storage unit 13. Alternatively, the simulator program may be inputted through an input device and stored in the simulator program storage unit 13.

The test information storage unit 14 stores therein two or more test information. The test information is information corresponding to one test item. Typically, the test information includes input information and an operation pattern. The input information is information to be sent to the test target program in order to test the test target program. The input information may be, e.g., an argument provided to the program. If the test information does not include an operation pattern, the operation pattern is assigned a default value (e.g., a normal pattern). The test information may have correct answer information indicating a normal operation result of the test target program. The correct answer information may be, e.g., a return value of the test target program or a value (e.g., an IO value) stored in a storage area of the hardware as an execution result of the test target program. The test information may have an IO value to be used for the operation of the simulator program. Although the test information storage unit 14 may be desirably a non-volatile storage medium, it may also be implemented by a volatile storage medium. Here, a process of storing the test information in the test information storage unit 14 is not specifically restricted. For example, the test information may be stored in the test information storage unit 14 via a storage medium, or the test program may be transmitted through a communication line or the like and stored in the test information storage unit 14. Alternatively, the test information may be inputted through an input device and stored in the test program storage unit 14.

The automatic test unit 15 reads out two or more test information from the test information storage unit 14 in sequence and sends the read-out test information to the test information receiving unit 16 in sequence. Typically, when the receiving unit 11 receives a test start instruction, the automatic test unit 15 reads out two or more test information from the test information storage unit 14 in sequence and sends the read-out test information to the test information receiving unit 16. The automatic test unit 15 carries out an automatic test by repetitively performing test items corresponding to a plurality of test information. Typically, the automatic test unit 15 may be implemented by a MPU, a memory, or the like. Typically, a processing sequence of the automatic test unit 15 may be executed by software, and the software may be stored in a storage medium such as ROM. However, it may be also possible to execute the processing sequence by using hardware (dedicated circuit).

The test information receiving unit 16 receives the test information. As discussed above, the test information typically includes the input information to be sent to the test target program so as to test the test target program and the operation pattern. The test information receiving unit 16 may receive the test information from the automatic test unit 15 or may receive the test information by a manual input from a user. The test information receiving unit 16 may be implemented by a MPU, a memory, or the like. Typically, a processing sequence of the test information receiving unit 16 may be executed by software, and the software may be stored in a storage medium such as ROM. However, it may be also possible to execute the processing sequence by using hardware (dedicated circuit). Alternatively, the test information receiving unit 16 may also be implemented by, e.g., a device driver of an input means such as a keyboard or by control software of a menu screen.

The test control unit 17 acquires an operation pattern included in the test information received by the test information receiving unit 16 and then sends the acquired operation pattern to the simulator program. Further, when the operation pattern is the default value, the test control unit 17 may not send the operation pattern to the simulator program. The test control unit 17 may acquire the IO value and the operation pattern included in the test information and then may send them to the simulator program. Further, the test control unit 17 may perform a process of acquiring the IO value written by the simulator program and outputting the acquired IO value. By way of example, the test control unit 17 may update the simulator program or data used by the simulator program based on the operation pattern. Such an update process may be regarded as the same process as sending the operation pattern to the simulator program. Further, the test control unit 17 may write the IO value in a preset file or variable. Such a process is also regarded as the same process as sending the IO value to the simulator program. Typically, the test control unit 17 may be implemented by a MPU, a memory, or the like. Typically, a processing sequence of the test control unit 17 may be executed by software, and the software may be stored in a storage medium such as ROM. However, it may be also possible to execute the processing sequence by using hardware (dedicated circuit).

The executing unit 18 sends the input information included in the test information to the test target program and executes the test target program. Further, the executing unit 18 executes the simulator program by using the program information as the execution result of the test target program and the operation pattern sent to the simulator program by the test control unit 17. That is, for example, as the simulator program is executed by the executing unit 18, an executed method (or function or the like) of the simulator program may differ depending on the operation pattern. For example, if the operation pattern differs, different methods may be executed although they have the same method name.

Further, the input information sent to the test target program may be NULL. Furthermore, the executing unit 18 may send the input information included in the test information to the test target program and then execute the test target program and also execute the simulator program by using the program information as the execution result of the test target program as well as the IO value and the operation pattern sent to the simulator program by the test control unit 17. Typically, the executing unit 18 may be implemented by a MPU, a memory, or the like. Typically, a processing sequence of the executing unit 18 may be executed by software, and the software may be stored in a storage medium such as ROM. However, it may be also possible to execute the processing sequence by using hardware (dedicated circuit).

The test result determination unit 19 acquires an operation result of the test target program executed by the executing unit 18 and determines normality or abnormality of the test by using the operation result and the correct answer information included in the test information. Then, the test result determination unit 19 outputs a determination result. Further, the test result determination unit 19 may read out the IO value and determine whether the read-out IO value is equal to an expected IO value (correct answer information included in the test information), and then outputs a determination result. The correct answer information is test result information, and it may include the return value of the test target program, the IO value as the operation result of the test target program, other information stored in the storage medium, or the like. Typically, the test result determination unit 19 may be implemented by a MPU, a memory, or the like. Typically, a processing sequence of the test result determination unit 19 may be executed by software, and the software may be stored in a storage medium such as ROM. However, it may be also possible to execute the processing sequence by using hardware (dedicated circuit).

Now, an operation of the program test device will be explained with reference to a flowchart of FIG. 2.

The receiving unit 11 determines whether a test start instruction is received or not (step S201). If the test start instruction is received, the process proceeds to step S202, and, if not, the process returns back to step S201.

The automatic test unit 15 substitutes 1 for a counter i (step S202).

The automatic test unit 15 determines whether the i^{th} test information exists in the test information storage unit (step S203). If the i^{th} information is found to exist, the process proceeds to step S204, and, if the i^{th} information does not exist, the process is terminated.

The test control unit 17 acquires an operation pattern included in the i^{th} test information (step S204).

The test control unit 17 sends the operation pattern acquired in step S204 to the simulator program. Here, the test control unit 17 may write the operation pattern acquired in step S204 in an operation pattern storage area (file, memory, or the like) accessible by the simulator program. This process may also be regarded as the same process as sending the operation pattern to the simulator program.

The test control unit 17 acquires an IO value included in the i^{th} test information (step S206).

The test control unit 17 sends the IO value acquired in step S206 to the simulator program (step S207). Here, the test control unit 17 may write the IO value acquired in step S206 in an IO value storage area (file, memory, or the like). This process may also be regarded as the same process as sending the IO value to the simulator program.

The executing unit 18 acquires input information included in the i^{th} test information (step S208).

The executing unit 18 sends the input information included in the test information to the test target program and executes the test target program (step S209). Typically, as the test target program is executed, the test target program and the simulator program exchange data, and the simulator program is also executed. When the simulator program is executed, the simulator program is operated by using the operation pattern received in step S205 and the IO value received in step S207. Further, in case that the test information does not include input information, the executing unit 18 does not send the input information to the test target program.

The test control unit 17 determines whether to perform a process of reading the IO value (step S210). For example, when the input information includes a command for reading the value, the test control unit 17 determines to perform the process of reading the IO value. If it is determined that the process of reading the IO value is to be performed, the process proceeds to step S211, whereas if it is determined that the process of reading the IO value is not to be performed, the process proceeds to step S212.

The test control unit 17 reads the IO value (step S211).

The test result determination unit 19 acquires an operation result of the test target program executed by the executing unit 18 and determines normality or abnormality of the test by using the operation result and the correct answer information included in the test information (step S212).

The test result determination unit 19 outputs a determination result determined in step S212 (step S213).

The automatic test unit 15 increases the counter i by an increment of 1 (step S214). Then, the process returns back to step S203.

In the flowchart of FIG. 2, the process is terminated by an interruption of a power-off or a process termination.

Hereinafter, a specific operation of the program test device in accordance with the first embodiment will be described by using two specific examples.

### EXAMPLE1

A test information management table shown in FIG. 3 is stored in the test information storage unit 14. The test information management table is a table for managing one or more test information. The test information management table stores therein one or more records including ‘ID’ and ‘test information’. The ‘ID’ identifies a record, and it is necessary for table management. In the present example, test information is written in the form of a program.

In the test information, a line (e.g., (1) of FIG. 3) starting from ‘#’ is a comment line. Lines (2) and (3) of FIG. 3 are methods for setting an IO value to be used for the operation of the simulator program. The line (2) of FIG. 3 indicates setting an IO value of ‘DO_FullOpen’ to an integer value ‘CONTROL’. The line (3) of FIG. 3 indicates setting an IO value of ‘DO_FullClose’ to an integer value ‘FULL_CLOSE’. Further, a line (4) of FIG. 3 indicates executing (testing) ‘InternalFullOpen( )’ of a test target program stored in the test target program storage unit 12. Here, ‘InternalFullOpen( )’ is an example of input information to be sent to the test target program. Further, in the line (4) of FIG. 3, ‘Common_OK’ is an example of correct answer information included in the test information. That is, if a return value as an execution result of ‘InternalFullOpen( )’ is ‘Common_OK’, it is determined that a test result at this time is normal. Further, a value (e.g., ‘0 ’ or ‘1 ’) corresponding to ‘Common_OK’ is predetermined.

Further, lines (5) and (6) of FIG. 3 are description for acquiring an IO value as an operation result of the simulator program and determining whether the acquired IO value is equal to an expected result (correct answer information). The line (5) of FIG. 3 indicates acquiring the IO value of ‘DO_FullOpen’ and determining whether the IO value is equal to an integer value ‘FULL_OPEN’. Here, ‘FULL_OPEN’ is correct answer information included in the test information. Further, the line (6) of FIG. 3 indicates acquiring the IO value of ‘DO_FullClose’ and determining whether the IO value is equal to the integer value ‘CONTROL’. Here, ‘CONTROL’ is correct answer information included in the test information. Further, the test information in FIG. 3 does not have an operation pattern. That is, the operation pattern is a default normal pattern (normal mode).

If a user inputs a test start instruction in this state, the receiving unit 11 receives the test start instruction.

Then, the automatic test unit 15 reads out the 1^{st} test information (a record of ‘ID=1’) from the test information management table of FIG. 3.

Thereafter, the test control unit 17 interprets and executes the record of ‘ID=1’ in FIG. 3. That is, the test control unit 17 ignores the comment line ((1) of FIG. 3) included in the 1^{st} test information. Subsequently, the test control unit 17 acquires the IO value ‘CONTROL’ of ‘DO_FullOpen’ included in the 1^{st} test information and stores it on a memory. Then, the test control unit 17 writes the value ‘CONTROL’ in an area of ‘DO_FullOpen’ so as to allow the simulator program to use the acquired IO value ‘CONTROL’ of ‘DO_FullOpen’ ((2) of FIG. 3). Further, the test control unit 17 acquires the IO value ‘FULL_CLOSE’ of ‘DO_FullClose’ included in the 1^{st} test information and stores it on the memory. Then, the test control unit 17 writes the value ‘FULL_CLOSE’ in an area of ‘DO_FullClose’ so as to allow the simulator program to use the acquired IO value ‘FULL_CLOSE’ of ‘DO_FullClose’ ((3) of FIG. 3).

Subsequently, the executing unit 18 acquires the input information ‘InternalFullOpen( )’ included in the 1^{st} test information. Then, the executing unit 18 executes ‘InternalFullOpen( )’ by running the test target program. Typically, as ‘InternalFullOpen( )’ is executed, the IO value is updated appropriately ((4) of FIG. 3).

Thereafter, the test result determination unit 19 acquires an operation result (a return value as an execution result of ‘InternalFullOpen( )’) of the test target program executed by the executing unit 18. Then, the test result determination unit 19 compares this return value with the correct answer information ‘Common_OK’ included in the test information. If the two are equal, it is determined that the test is normal. If the two are different, however, it is determined that the test is abnormal. Here, for example, assume that the return value as the execution result of ‘InternalFullOpen( )’ is ‘Common_OK’. Since the return value is equal to the correct answer information ‘Common_OK’, it is determined that the test at this step is normal ((4) of FIG. 3).

Subsequently, the test control unit 17 reads the IO value of ‘DO_FullOpen’ by interpreting and executing (5) and (6) of FIG. 3. Then, the test result determination unit 19 determines whether the IO value of ‘DO_FullOpen’ as an operation result of the test target program is equal to the correct answer information ‘FULL_OPEN’ included in the test information. If the two are equal, it is determined that the test is normal. If the two are different, however, it is determined that the test is abnormal. Likewise, the test result determination unit 19 acquires the IO value of ‘DO_FullClose’ as an operation result of the test target program and determines whether the acquired IO value is equal to the correct answer information ‘FULL_CLOSE’ included in the test information. If the two are equal, it is determined that the test is normal, whereas if the two are different, it is determined that the test is abnormal. Then, the test result determination unit 19 outputs a determination result (e.g., ‘normal’). Here, the determination result may be outputted by being displayed on a display or stored in a storage medium. Further, when outputting the result, the test result determination unit 19 outputs the identification number ID of the test information and the determination result corresponding to the ID.

Through the above-described process, the processing of the test information of ‘ID=1’ is terminated. Further, in the process of determining normality/abnormality by the test result determination unit 19, the test result determination unit 19 outputs, e.g., a determination result indicating ‘abnormality’ if it is determined that the IO value and the correct answer information are not equal.

Thereafter, the automatic test unit 15 reads out the 2^{nd} or next test information (a record of ‘ID=2’ or next) in sequence. In the same manner as the 1^{st} test information, the read-out test information is interpreted and executed and, then, a determination result is outputted.

Further, since the process of interpreting and executing the test information in (1) to (6) of FIG. 3 is well-known in the pertinent art, detailed description thereof will be omitted.

### EXAMPLE 2

A test information management table shown in FIG. 4 is stored in the test information storage unit 14. In FIG. 4, test information of ‘ID=1’ is information for performing a test of a normal operation of a DRP (Dry Vacuum Pump). Further, test information of ‘ID=2’ is information for performing a test of time-out (abnormal operation) of the DRP. In FIG. 4, ‘TagRawWrite’ is a function (method) for setting an IO value. That is, (1) indicates setting an IO value ‘DO_RUN’ to a value ‘STOP’; (2) indicate setting an IO value ‘DI_RUN’ to a value ‘STOP’; and (3) indicates setting an IO value ‘DI_ALARM’ to a value ‘NORMAL’. Further, ‘TagRead’ is a function for acquiring an IO value and determining normality/abnormality. That is, (4) indicates determining whether the IO value ‘DO_RUN’ is set to the value ‘STOP’; (5) indicates determining whether the IO value ‘DI_RUN’ is set to the value ‘STOP’; and (6) indicates determining whether the IO value ‘DI_ALARM’ is set to the value ‘NORMAL’. ‘SetPatarn’ is a function for setting an operation pattern. That is, (7) indicates setting an operation pattern of ‘DO_RUN’ to ‘NORMAL’. Further, (9) indicates determining whether an IO value ‘DI_RUN’ is set to a value ‘RUN’.

If a user inputs a test start instruction in this state, the receiving unit 11 receives the test start instruction.

Then, the automatic test unit 15 reads out the 1^{st} test information (a record of ‘ID=1’) from the test information management table of FIG. 4.

Thereafter, the test control unit 17 interprets and executes information (functions) in the record of ‘ID=1’ in FIG. 4 in sequence. That is, referring to a line (1) of FIG. 4, the test control unit 17 acquires the IO value ‘STOP’ of ‘DO_RUN’ included in the 1^{st} test information and stores it on a memory. Then, the test control unit 17 writes the acquired IO value ‘STOP’ of ‘DO-RUN’ in an area of ‘DO-RUN’ so as to allow the simulator program to use the IO value. Further, referring to a line (2) of FIG. 4, the test control unit 17 acquires the IO value ‘STOP’ of ‘DI_RUN’ included in the 1^{st} test information and stores it on a memory. Then, the test control unit 17 writes the acquired IO value ‘STOP’ of ‘DI-RUN’ in an area of ‘DI-RUN’ so as to allow the simulator program to use the IO value. Further, referring to a line (3) of FIG. 4, the test control unit 17 acquires an IO value ‘NORMAL’ of ‘DI_ARARM’ included in the 1^{st} test information and stores it on a memory. Then, the test control unit 17 writes the acquired IO value ‘NORMAL’ of ‘DI_ARARM’ in an area of ‘DI_ARARM’ so as to allow the simulator program to use the IO value.

Subsequently, referring to a line (4) of FIG. 4, the test control unit 17 acquires the IO value of ‘DO_RUN’. Then, the test result determination unit 19 determines whether the IO value of ‘DO_RUN’ is ‘STOP’ or not. Referring to a line (5) of FIG. 4, the test control unit 17 acquires the IO value of ‘DI_RUN’. Then, the test result determination unit 19 determines whether the IO value of ‘DI_RUN’ is ‘STOP’ or not. Further, referring to a line (6) of FIG. 4, the test control unit 17 acquires the IO value of ‘DI_ARARM’. Then, the test result determination unit 19 determines whether the IO value of ‘DI_ARARM’ is ‘NORMAL’ or not.

Then, referring to a line (7) of FIG. 4, the test control unit 17 acquires an operation pattern ‘DO_RUN, NORMAL’ included in the 1^{st} test information. The operation pattern ‘DO_RUN, NORMAL’ indicates that an operation of ‘DO_RUN’ is ‘NORMAL’. The test control unit 17 then sends ‘DO_RUN, NORMAL’ to the simulator program. That is, the operation of ‘DO_RUN’ is set to be ‘NORMAL’.

Subsequently, referring to a line (8) of FIG. 4, the executing unit 18 acquires input information ‘DRP.Run( )’ included in the 1^{st} test information. Then, the executing unit 18 executes ‘DRP.Run( )’ by running a test target program. By execution of ‘DRP.Run( )’, the DRP is operated and the IO value is updated appropriately.

Thereafter, the test result determination unit 19 acquires an operation result (a return value as an execution result of ‘DRP.Run( )’) of the test target program executed by the executing unit 18. Then, the test result determination unit 19 compares this return value with the correct answer information included in the test information. If the two are equal, it is determined that the test is normal. If the two are different, however, it is determined that the test is abnormal.

Then, referring to a line (9) of FIG. 4, the test control unit 17 acquires input information ‘TagRead(DI_RUN, RUN)’ included in the 1^{st} test information. Then, the test control unit 17 reads the IO value of ‘DI_RUN’ by interpreting and executing ‘TagRead(DI_RUN, RUN)’. The test result determination unit 19 determines whether the IO value of ‘DI_RUN’ as the operation result of the test target program is equal to the correct answer information ‘RUN’ included in the test information. If the two are equal, the test result determination unit 19 determines that the test is normal, whereas if the two are not equal, the test result determination unit 19 determines that the test is abnormal. Then, the test result determination unit 19 outputs a determination result (e.g., ‘normal’). Here, the determination result may be outputted by being displayed on a display or stored in a storage medium. Further, when outputting the result, the test result determination unit 19 outputs the identification number ID of the test information and the determination result corresponding to the ID.

Through the above-described process, the processing of the test information of ‘ID=1’ is terminated. Further, in the process of determining normality/abnormality by the test result determination unit 19, the test result determination unit 19 outputs, e.g., a determination result indicating ‘abnormality’ if it is determined that the IO value and the correct answer information are not equal.

Thereafter, the automatic test unit 15 reads out the 2^{nd} test information (a record of ‘ID=2’) from the test information management table of FIG. 4.

Then, the test control unit 17 interprets and executes functions in the record of ‘ID=2’ of FIG. 4 in sequence. That is, the test control unit 17 processes (10) to (15) in the record of ‘ID=2’ in the same manner as (1) to (6).

Next, the test control unit 17 acquires an operation pattern ‘DO_RUN, TIMEOUT’ from a line (16) of the 2^{nd} test information. The operation pattern ‘DO_RUN, TIMEOUT’ indicates that an operation of ‘DO_RUN’ is ‘TIMEOUT’. Then, the test control unit 17 sends ‘DO_RUN, TIMEOUT’ to the simulator program. That is, the operation of ‘DO_RUN’ is set to be ‘TIMEOUT’.

Subsequently, the executing unit 18 acquires input information ‘DRP.Run( )’ from a line (17) of the 2^{nd} test information. Then, the executing unit 18 executes ‘DRP.Run( )’ by running the test target program. By execution of ‘DRP.Run( )’, the DRP is operated and the IO value is updated appropriately.

Then, the test result determination unit 19 acquires an operation result (a return value as an execution result of ‘DRP.Run( )’) of the test target program executed by the executing unit 18. Then, the test result determination unit compares this return value with the correct answer information included in the test information. If the two are equal, it is determined that the test is normal. If the two are different, however, it is determined that the test is abnormal.

Afterward, the test control unit 17 acquires input information ‘TagRead(DI_RUN, STOP)’ included in the 2^{nd} test information. Then, the test control unit 17 reads the IO value of ‘DI_RUN’ by interpreting and executing ‘TagRead(DI_RUN, STOP)’. The test result determination unit determines whether the IO value of ‘DI_RUN’ as the operation result of the test target program is equal to the correct answer information ‘STOP’ included in the test information. If the two are equal, the test control unit 17 determines that the test is normal, whereas if the two are not equal, the test control unit 17 determines that the test is abnormal. Then, the test result determination unit 19 outputs a determination result (e.g., ‘normal’). Here, the determination result may be outputted by being displayed on a display or stored in a storage medium. Further, when outputting the result, the test result determination unit 19 outputs the identification number ID of the test information and the determination result corresponding to the ID.

Through the above-described process, the processing of the test information of ‘ID=2’ is terminated. Further, in the process of determining normality/abnormality by the test result determination unit 19, the test result determination unit 19 outputs, e.g., a determination result indicating ‘abnormality’ if it is determined that the IO value and the correct answer information are not equal.

Then, the automatic test unit 15 reads out the 3^{rd} or next test information (a record of ‘ID=3’ or next) in sequence. In the same manner as the 1^{st} and 2^{nd} test information, the read-out test information is interpreted and executed and, then, a determination result is outputted.

Now, the program test device in accordance with the present embodiment will be described. FIG. 5 illustrates a schematic block diagram of a conventional program test device. That is, the conventional program test device includes an automatic test program 51; a test target program 52 and a simulator program 53. The automatic test program 51 executes one or more test items automatically. The test target program 52 is the same as the test target program of the test target program storage unit 12, and it is a program to be tested. The simulator program 53 is the same as the simulator program of the simulator program storage unit 13, and it is a program for simulating a response of the apparatus. The simulator program has a function (stub) of a normal pattern and a function (stub) of an abnormal pattern for a single function (stub). Further, in FIG. 5, ‘communication’ may be data communications, data transmission, function calls, or the like. That is, ‘communication’ implies cooperation between the test target program 52 and the simulator program 53.

In the program test device configured as described above, it is necessary to test an abnormal case such as generation of an alarm from the apparatus or generation of start-up time-out as well as a normal case. That is, in the program test device, a test needs to be performed for two or more operation patterns: a normal pattern and an abnormal pattern such as a non-response pattern of making no response, an alarm pattern of generating an alarm or a halfway normal pattern showing an abnormal operation after a normal operation is shown halfway. In the conventional program test device, however, the test target program needs be tested after an operation pattern is previously set in the simulator program. That is, in case of performing tests of a plurality of operation patterns, the tests have been performed while the operation patterns are manually updated and functions are changed. Thus, it has been impossible to automatically perform the tests for the plurality of operation patterns.

Meanwhile, a schematic block diagram of the program test device in accordance with the above-described first embodiment is shown in FIG. 6. The program test device of the present embodiment includes an automatic test program 61; a test target program 62; a simulator program 63; and an automatic control program 64. The automatic control program 64 corresponds to the above-described test control unit 17. That is, the automatic control program 64 is capable of automatically and consecutively testing a plurality of operation patterns by providing an interface for changing the operation patterns from the automatic test program 61 such as NUnit to the simulator program 63. Further, since the program test device also provides a function of updating an IO state (IO value) by the automatic control program 64, an abnormal operation of the apparatus or the like can be also simulated by the test target program 62. The program test device having the above-described configuration is capable of performing tests of a normal case and an abnormal case by using a single test program. Furthermore, by updating the IO state (IO value) and rendering it readable, it is possible to check an actual value changed by the simulator program ?3 as well as an execution result of a control instruction. Thus, tests of an input (input process) and an output (output process) of the test target program ?2 are enabled. For further description of NUnit, refer to, e.g., a website ‘http://www.divakk.co.jp/aoyagi/csharp_tips_nunit.html’.

In accordance with the present embodiment as described above, even in case that there is a hardware error for the test target program, the test of the test target program can be easily performed. More specifically, tests for a plurality of operation patterns can be automatically and consecutively performed. Furthermore, in accordance with the present embodiment, since the program test device also provides the function of updating the IO state (IO value) by the automatic control program 64, an abnormal operation of the apparatus or the like can also be accurately simulated by the test target program 62. Moreover, in accordance with the present embodiment, by rendering the IO value readable, an actual change in the value of the simulator program as well as the execution result of the control instruction can be checked. Thus, tests of the input and the output of the test target program are enabled.

Furthermore, in the present embodiment, there is no particular restriction in the contents of the test information.

Further, the process in the present embodiment may be executed by software, and the software may be distributed by software download method or the like. Alternatively, it is possible to record this software in a storage medium such as a CD-ROM to distribute it. This is also applicable to other embodiments of the present invention to be described later. Further, in the present embodiment, the software for executing the program test device may be a program as follows. That is, this program may be a program for allowing a computer to function as: the test information receiving unit which receives the test information including the operation pattern and the input information to be sent to the test target program so as to test the test target program; the test control unit which acquires the operation pattern included in the test information and sends the acquired operation pattern to the simulator program for simulating a hardware operation; and the executing unit which sends the input information included in the test information to the test target program and executes the test target program and also executes the simulator program by using the program information as an execution result of the test target program and the operation pattern sent to the simulator program by the test control unit.

Desirably, in the above-stated program, the test information may include an IO value to be used for an operation of the simulator program, and the test control unit acquires the operation pattern and the IO value included in the test information and sends the acquired operation pattern and the IO value to the simulator program, and the executing unit sends the input information included in the test information to the test target program and executes the test target program, and also executes the simulator program by using the program information as an execution result of the test target program as well as the operation pattern and the IO value sent to the simulator program by the test control unit.

Moreover, in the above-described program, the test control unit may also perform a process of acquiring the IO value as an operation result of the simulator program and outputting the IO value.

### Second Embodiment

In a second embodiment, a program test device that sends normal test information to hardware and abnormal test information to a simulator program will be described. The program test device in this embodiment performs a test with improved accuracy by using the hardware in case of a normal pattern, whereas it performs a test by using the simulator program in case of an abnormal pattern. By performing such a process, only a test case of which state (typically, an abnormal pattern) is difficult to generate by the hardware can be tested by software.

FIG. 7 is a block diagram of a program test device 2 in accordance with the second embodiment. The program test device 2 includes a receiving unit 11, a test target program storage unit 12, a simulator program storage unit 23, a test information storage unit 14, an automatic test unit 25, a test information receiving unit 16, a test control unit 27, an executing unit 28 and a test result determination unit 29.

The simulator program storage unit 23 stores therein a simulator program for simulating a hardware error operation. Typically, the simulator program performs an operation based on program information transmitted from a test target program. Here, the simulator program may perform an operation of only returning an error code. Although the simulator program storage unit 23 may be desirably a non-volatile storage medium, it may also be implemented by a volatile storage medium. Here, a process of storing the simulator program in the simulator program storage unit 23 is not specifically restricted. For example, the simulator program may be stored in the simulator program storage unit 23 via a storage medium, or the simulator program may be transmitted through a communication line or the like and stored in the simulator program storage unit 23. Alternatively, the simulator program may be inputted through an input device and stored in the simulator program storage unit 23.

The test control unit 27 acquires an operation pattern included in test information received by the test information receiving unit 16. Typically, the test control unit 27 may be implemented by a MPU, a memory, or the like. Typically, a processing sequence of the test control unit 27 may be executed by software, and the software may be stored in a storage medium such as ROM. However, it may be also possible to execute the processing sequence by using hardware (dedicated circuit).

The executing unit 28 sends input information included in the test information to the test target program and executes the test target program. Further, the executing unit 28 determines whether an operation pattern acquired by the test control unit 27 is a normal pattern or not. If the operation pattern is a normal pattern, program information as an execution result of the test target program is sent to the hardware and the hardware is operated. If the operation pattern is not a normal pattern, the executing unit 28 executes the simulator program by using the program information as the execution result of the test target program. Here, a case which is not a normal pattern refers to an abnormal pattern including a non-response pattern, an alarm pattern and a halfway normal pattern. Further, the program information is sent from the test target program to the hardware. Typically, the executing unit 28 can be implemented by a MPU, a memory, or the like. Typically, a processing sequence of the executing unit 28 may be executed by software, and the software may be stored in a storage medium such as ROM. However, it may be also possible to execute the processing sequence by using hardware (dedicated circuit).

Now, an operation of the program test device will be explained with reference to a flowchart of FIG. 8. In FIG. 8, redundant description of steps already described in the flowchart of FIG. 2 will be omitted.

The executing unit 28 executes a test (step S901). A test execution process will be elaborated with reference to the flowchart of FIG. 8.

In the flowchart of FIG. 8, the process is terminated by an interrupt of power-off or a process termination.

Hereinafter, the test execution process will be explained with reference to a flowchart of FIG. 9. In FIG. 9, redundant description of steps already described in the flowchart of FIG. 2 will be omitted.

The test control unit 27 determines whether an operation pattern acquired in step S204 is a normal pattern or not (step S901). If the operation pattern is a normal pattern, the process proceeds to step S902, and, if not, the process proceeds to step S217.

The test control unit 27 writes the IO value acquired in step S206 as an IO value of the hardware in the hardware. The process of writing the IO value in the hardware may be a process of sending the IO value to the hardware.

The executing unit 28 executes a test target program (step S903).

The test control unit 27 acquires program information as an execution result of step S903 (step S904).

The test control unit 27 determines whether the operation pattern acquired in step S204 is a normal pattern or not (step S905). If the operation pattern is a normal pattern, the process proceeds to step S906, and, if not, the process proceeds to step S207.

The executing unit 28 sends the program information acquired in step S904 to the hardware and operates the hardware (step S906).

The executing unit 28 executes a simulator program by using the program information acquired in step S904 (step S907).

The test control unit 27 determines whether an execution result of step S906 or step S907 is received (step S908). If the execution result is received, the process proceeds to step S909, and if not, the process returns back to step S908.

The test control unit 27 determines whether a test of the i^{th} test information is terminated (step S909). If it is determined that the test is terminated, the process proceeds to step S910, and if it is determined that the test is not terminated, the process returns back to step S903.

The test result determination unit 29 acquires an IO value from the hardware or information written by the simulator program (Step S910). Then, the process proceeds to step S212.

Here, it should be noted that the process sequence depicted in the flowchart of FIG. 9 is nothing more than an example.

Hereinafter, a specific operation of the program test device in accordance with the second embodiment will be explained.

A test information management table shown in FIG. 4 is stored in the test information storage unit 14.

In this state, if a user inputs a test start instruction, the receiving unit 11 receives the test start instruction.

Then, the automatic test unit 25 reads out the 1^{st} test information (a record of ‘ID=1’) from the test information management table of FIG. 4.

Then, the test control unit 27 interprets and executes functions in the record of ‘ID=1’ of FIG. 4 in sequence. That is, the test control unit 27 acquires an IO value ‘STOP’ of ‘DO_RUN’ included in the 1^{st} test information and stores the acquired IO value on a memory. Afterward, the test control unit 27 sends the acquired IO value ‘STOP’ of ‘DO_RUN’ to the hardware, and the hardware writes the IO value ‘STOP’ in an area of ‘DO_RUN’. Further, the test control unit 27 acquires an IO value ‘STOP’ of ‘DI_RUN’ included in the 1^{st} test information and stores the acquired IO value on the memory. Then, the test control unit 27 sends the acquired IO value ‘STOP’ of ‘DI_RUN’ to the hardware, and the hardware writes the IO value ‘STOP’ in an area of ‘DI_RUN’. Further, the test control unit 27 also acquires an IO value ‘NORMAL’ of ‘DI_ARARM’ included in the 1^{st} information and stores the acquired IO value on the memory. Then, the test control unit 27 sends the acquired IO value ‘NORMAL’ of ‘DI_ARARM’ to the hardware, and the hardware writes the IO value ‘NORMAL’ in an area of ‘DI_ARARM’.

Subsequently, the test control unit 27 reads out the IO value of ‘DO_RUN’ from the hardware. Then, the test result determination unit 29 determines whether the IO value of ‘DO_RUN’ is ‘STOP’ or not. Furthermore, the test control unit 27 reads out the IO value of ‘DI_RUN’ from the hardware. Then, the test result determination unit 29 determines whether the IO value of ‘DI_RUN’ is ‘STOP’ or not. Further, the test control unit 27 reads out the IO value of ‘DI_ARARM’ from the hardware. Then, the test result determination unit 29 determines whether the IO value of ‘DI_ARARM’ is ‘NORMAL’ or not.

Thereafter, the test control unit 27 acquires an operation pattern ‘DO_RUN, NORMAL’ included in the 1^{st} test information. The operation pattern ‘DO_RUN, NORMAL’ indicates that an operation of ‘DO_RUN’ is ‘NORMAL’.

Afterward, the executing unit 28 acquires input information ‘DRP.Run( )’ included in the 1^{st} test information.

Then, the executing unit 28 executes ‘DRP.Run( )’ by running a test target program. Then, the executing unit 28 acquires an execution result of ‘DRP.Run( )’.

Then, the executing unit 28 recognizes that the operation pattern is a normal pattern with reference to the operation pattern ‘DO_RUN, NORMAL’ acquired by the test control unit 27. The executing unit 28 previously stores therein a pair of information indicating ‘NORMAL’ and ‘normal pattern’.

The executing unit 28 sends program information as an execution result of the test target program (i.e., an execution result of ‘DRP.Run( )’) to the hardware and operates the hardware.

Then, the executing unit 28 acquires an execution result of the hardware. Typically, by the execution of ‘DRP.Run( )’, the IO value in the hardware can be updated appropriately. Then, the executing unit 28 sends an execution result of the hardware to the test target program.

Subsequently, the test result determination unit 29 acquires an operation result (a return value as execution result of ‘DRP.Run( )’) of the test target program executed by the executing unit 28. Then, the test result determination unit 29 compares this return value with correct answer information included in the test information. If the two are equal, it is determined that the test is normal. If the two are different, however, it is determined that the test is abnormal.

Thereafter, the test control unit 27 acquires input information ‘TagRead(DI_RUN, RUN)’ included in the 1^{st} test information. Then, the test control unit 27 reads out the IO value of ‘DI_RUN’ from the hardware by interpreting and executing ‘TagRead(DI_RUN, RUN)’. Then, the test result determination unit 29 determines whether the IO value of ‘DI_RUN’ as the operation result of the test target program is equal to the correct answer information ‘RUN’ included in the test information. If the two are equal, the test result determination unit 29 determines that the test is normal, whereas if the two are different, the test result determination unit 29 determines that the test is abnormal. Then, the test result determination unit 29 outputs a determination result (e.g., ‘normal’). Here, the determination result may be outputted by being displayed on a display or stored in a storage medium. Further, when outputting the result, the test result determination unit 29 outputs the identification number ID of the test information and the determination result corresponding to the ID.

Through the above-described process, the processing of the test information of ‘ID=1’ is terminated. Further, in the process of determining normality/abnormality by the test result determination unit 29, the test result determination unit 29 outputs, e.g., a determination result indicating ‘abnormality’ if it is determined that the IO value and the correct answer information are not equal.

Thereafter, the automatic test unit 25 reads out the 2^{nd} test information (a record of ‘ID=2’) from the test information management table of FIG. 4.

Then, the test control unit 27 interprets and executes the record of ‘ID=2’ of FIG. 4 in sequence. That is, the test control unit 27 processes (10) to (15) in the record of ‘ID=2’ in the same manner as (1) to (6). The processes (1) to (6) is described in the aforementioned present embodiment.

Next, the test control unit 27 acquires an operation pattern ‘DO_RUN, TIMEOUT’ from a line (16) of the 2^{nd} test information.

Subsequently, the executing unit 28 acquires the input information ‘DRP.Run( )’ included in the 1^{st} test information. Then, the executing unit 28 executes ‘DRP.Run( )’ by running the test target program. Then, the executing unit 28 acquires an execution result of ‘DRP.Run( )’.

Thereafter, the executing unit 28 determines that the operation pattern is not a normal pattern with reference to the operation pattern ‘DO_RUN, TIMEOUT’ acquired by the test control unit 27. Further, the executing unit 28 may previously memorize information on one or more operation pattern other than a normal pattern and determine that the operation pattern acquired by the test control unit 27 is not a normal operation pattern if the operation pattern acquired by the test control unit 27 is equal to any one information on the operation patterns other than the normal pattern memorized in the executing unit 28. Alternatively, the executing unit 28 may previously memorize information on a normal operation pattern and determine that the operation pattern acquired by the test control unit 27 is not a normal operation pattern if the operation pattern acquired by the test control unit 27 is not equal to the information of normal operation pattern memorized in the executing unit 28.

Then, the executing unit 28 executes a simulator program by using the program information as the execution result of the test target program (i.e., the execution result of ‘DRP.Run( )’. The simulator program is a simulator program (stub or the like) for an abnormal pattern. The executing unit 28 then sends an execution result of the simulator program to the test target program.

Subsequently, the test result determination unit 29 acquires the operation result (the return value the execution result of ‘DRP.Run( )’) of the test target program executed by the executing unit 28. Then, the test result determination unit 29 compares this return value with the correct answer information included in the test information. If the two are equal, it is determined that the test is normal. If the two are different, however, it is determined that the test is abnormal.

Thereafter, the test control unit 27 acquires input information ‘TagRead(DI_RUN, STOP)’ included in the 1^{st} test information. Then, the test control unit 27 reads out the IO value of ‘DI_RUN’ from the hardware by interpreting and executing ‘TagRead(DI_RUN, STOP)’. Then, the test result determination unit 29 determines whether the IO value of ‘DI_RUN’ as the operation result of the test target program is equal to the correct answer information ‘STOP’ included in the test information. If the two are equal, the test result determination unit 29 determines that the test is normal, whereas if the two are different, the test result determination unit 29 determines that the test is abnormal. Then, the test result determination unit 29 outputs a determination result (e.g., ‘normal’). Here, the determination result may be outputted by being displayed on a display or stored in a storage medium. Further, when outputting the result, the test result determination unit 29 outputs the identification number ID of the test information and the determination result corresponding to the ID.

Through the above-described process, the processing of the test information of ‘ID=2’ is terminated. Further, in the process of determining normality/abnormality by the test result determination unit 29, the test result determination unit 29 outputs, e.g., a determination result indicating ‘abnormality’ if it is determined that the IO value and the correct answer information are not equal.

In accordance with the second embodiment as discussed above, provided is the program test device that sends normal test information to the hardware and abnormal test information to the simulator program. With such a program test device, a test can be performed with improved accuracy by using the hardware in case of a normal pattern, whereas a test can be performed by using the simulator program in case of an abnormal pattern. By performing such a process, only a test case of which state (typically, an abnormal pattern) is difficult to generate by the hardware can be tested by software. Further, a test case of which state (typically, a normal pattern) can be easily generated by the hardware can be tested highly accurately by using the actually operated hardware.

Furthermore, in the specific example of the present embodiment, although the executing unit 28 and the hardware exchange data only one time, they may exchange data continuously. Likewise, although the executing unit 28 and the simulator program also exchange data only one time, they may exchange data continuously.

In the present embodiment, the software for executing the program test device may be a program as follows. This program allows a computer to function as: the test information receiving unit that receives the test information including the operation pattern and the input information to be sent to a test target program to test the test target program; the test control unit that acquires the operation pattern included in the test information; and the executing unit that sends the input information included in the test information to the test target program and executes the test target program, sends the program information as an execution result of the test target program to the hardware to thereby operate the hardware if the operation pattern acquired by the test control unit is a normal pattern, and executes the simulator program by using the program information as the execution result of the test target program if the operation pattern acquired by the test control unit is not a normal pattern.

FIG. 10 illustrates an exterior view of a computer that executes the above-described programs and thus implements the program test device in accordance with the present embodiments. The above-described embodiments may be implemented by computer hardware and a computer program operated on the computer hardware. FIG. 10 is a schematic view of a computer system 340, and FIG. 11 is a block diagram of the computer system 340.

In FIG. 10, the computer system 340 includes a computer 341 having a FD (Flexible Disk) drive and CD-ROM (Compact Disk Read Only Memory) drive, a keyboard 342, a mouse 343 and a monitor 344.

In FIG. 11, the computer 341 includes, in addition to a FD drive 3411 and a CD-ROM drive 3412, a CPU (Central Processing Unit) 3413; a bus 3414 connected with the CPU 3413, the CD-ROM drive 3412 and the FD drive 3411; a ROM (Read-Only Memory) 3415 for storing therein, e.g., a boot-up program; a RAM (Random Access Memory) 3416 connected with the CPU 3413 and serving to temporarily store a command of an application program while providing a temporary storage area; and a hard disk 3417 for storing therein an application program, a system program and data. Although not shown, the computer 341 may additionally include a network card allowing an access to a LAN.

A program for allowing the computer system 340 to perform the functions of the program test device in accordance with the above-described embodiments may be stored in the CD-ROM 3501 or the FD 3502, and the CD-ROM 3501 or the FD 3502 is inserted into the CD-ROM drive 3412 or the FD drive 3411 and is then sent to the hard disk 3417. Instead, the program may be sent to the computer 341 through a non-illustrated network and stored in the hard disk 3417. The program is loaded into the RAM 3416 when executed. Alternatively, the program may be directly loaded from the CD-ROM 3501, the FD 3502, or the network.

The program may not necessarily include, e.g., an operating system OS or a third party program for allowing the computer 341 to perform the functions of the program test device in accordance with the above-described embodiments. The program only needs to include commands for calling a proper function (module) and acquiring a desired result under a controlled condition. Since the way the computer system 340 is operated 340 is well known in the pertinent art, detailed description thereof will be omitted.

Further, a single computer or a plurality of computers may be used to execute the above-described program. That is, centralized processing or distributed processing can be performed.

Further, in the above-described embodiments, each process (function) may be implemented through centralized processing by a single apparatus (system) or through distributed processing by a plurality of apparatuses.

The present invention is not limited to the above-described embodiments. It would be understood by those skilled in the art that various modifications may be made and the modifications are also included within the scope of the present invention.

### INDUSTRIAL APPLICABILITY

The program test device in accordance with the present invention has many advantages in that it is capable of easily performing an automatic test of a test target program even in case there is a hardware error and it is useful as a program test device.

### BRIEF DESCRIPTION OF THE DRAWINGS

FIG. 1 is block diagram of a program test device in accordance with a first embodiment of the present invention.

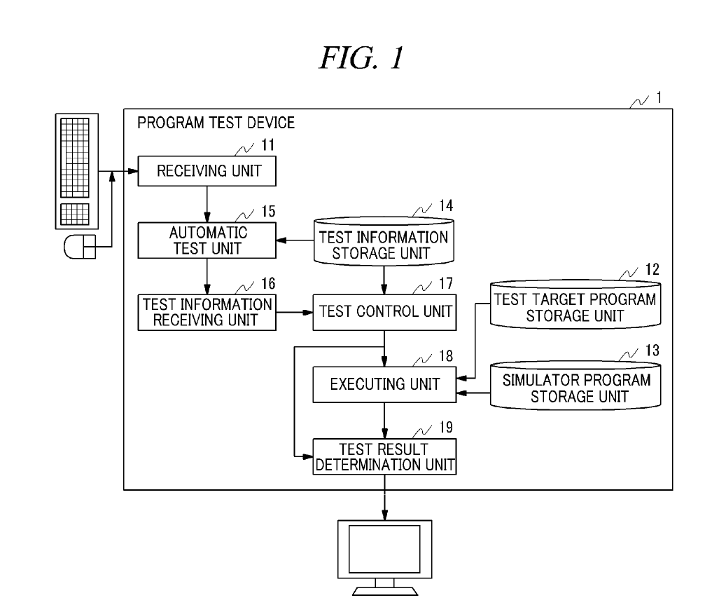

FIG. 2 is a flowchart for describing an operation of the program test device.

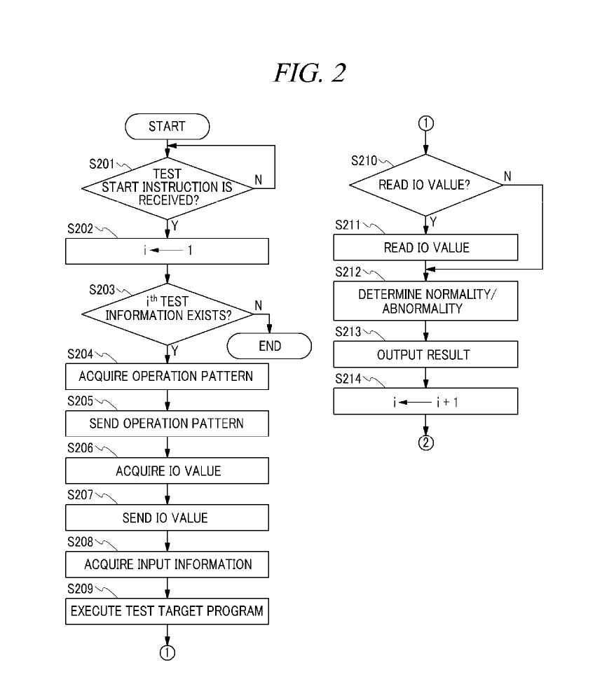

FIG. 3 illustrates a test information management table.

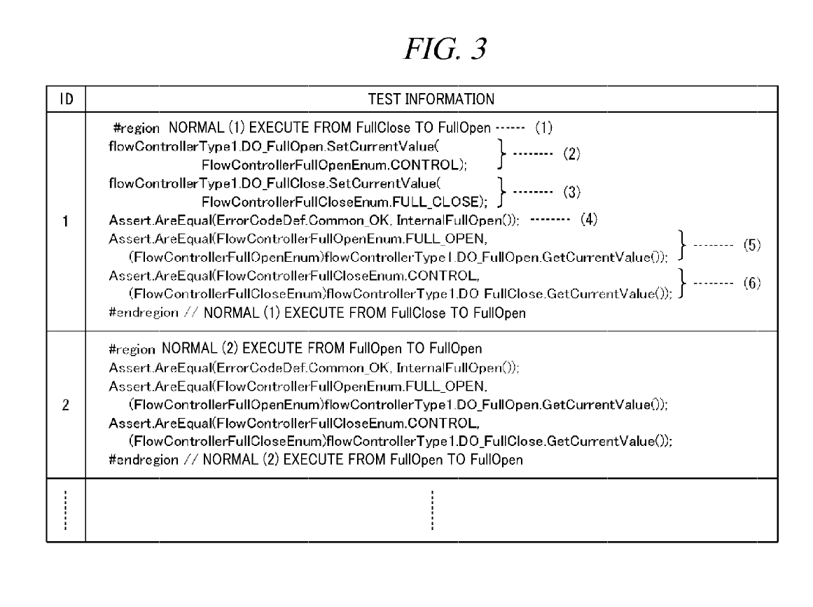

FIG. 4 illustrates a test information management table.

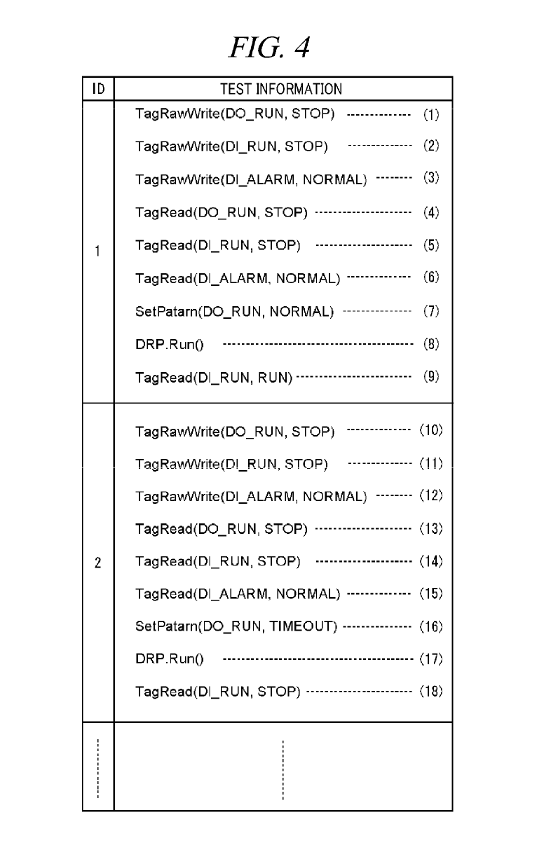

FIG. 5 is a schematic block diagram of a conventional program test device.

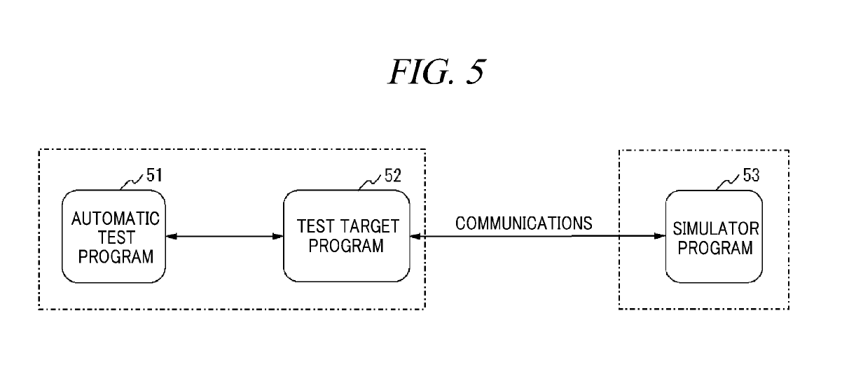

FIG. 6 is a schematic block diagram of the program test device in accordance with the first embodiment.

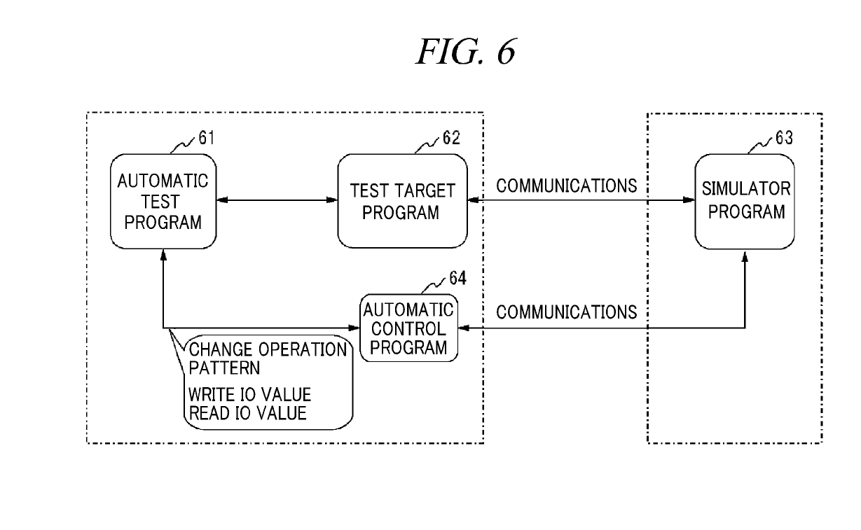

FIG. 7 is a block diagram of a program test device in accordance with a second embodiment of the present invention.

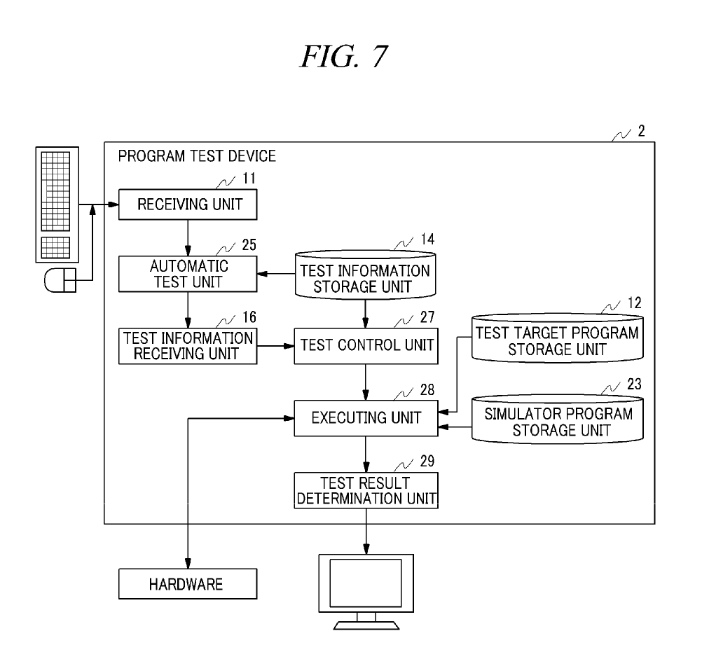

FIG. 8 is a flowchart for describing an operation of the program test device in accordance with the second embodiment.

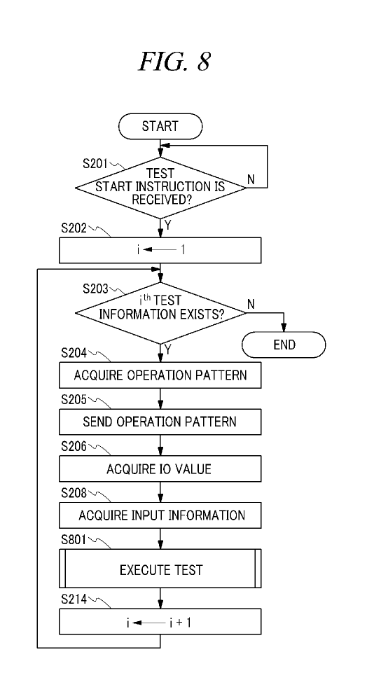

FIG. 9 is a flowchart for describing an operation of a test execution process.

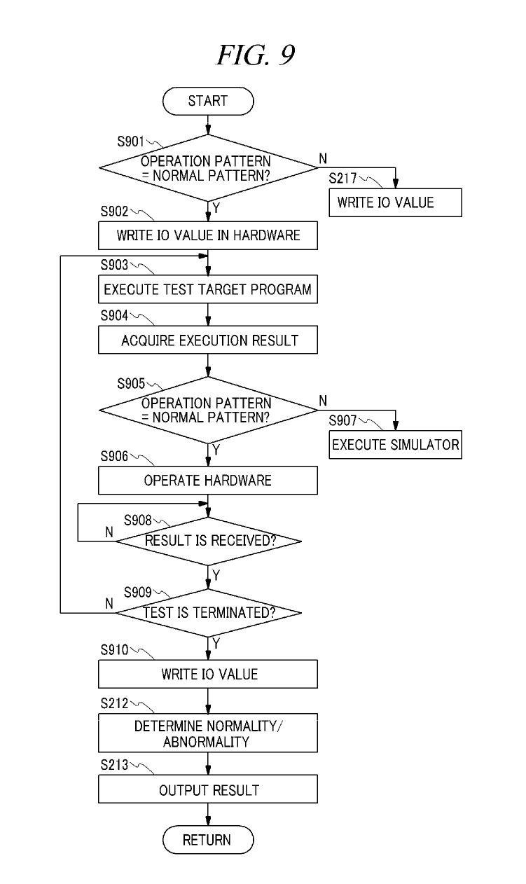

FIG. 10 is schematic diagram of a computer system.

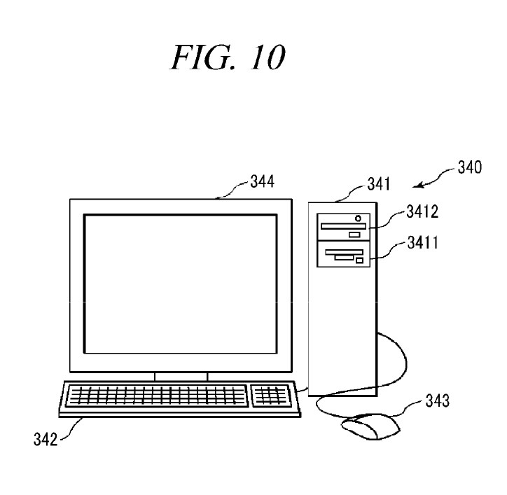

FIG. 11 is a block diagram of the computer system.

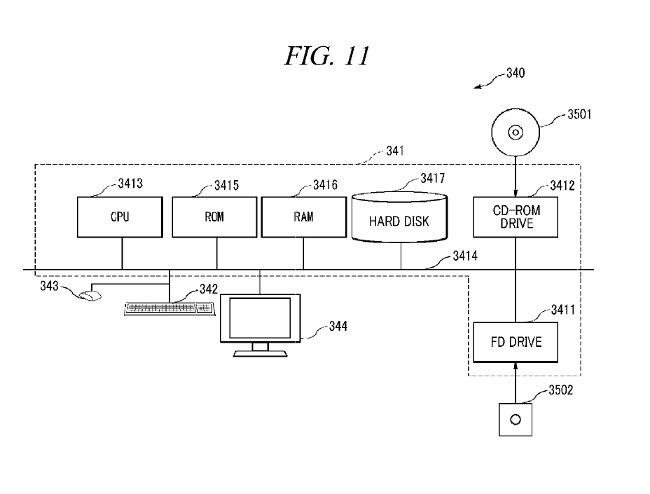

What is claimed is:

1. A program test device comprising:
a test target program storage unit that stores therein a test target program;
a simulator program storage unit that stores therein a simulator program for simulating an operation of hardware and for performing an operation based on an operation pattern and program information sent from the test target program;
a test information receiving unit that receives test information including the operation pattern and input information to be sent to the test target program so as to test the test target program;
a test control unit that acquires the operation pattern included in the test information and sends the acquired operation pattern to the simulator program; and
an executing unit that sends the input information included in the test information to the test target program and executes the test target program, and also executes the simulator program by using the program information as an execution result of the test target program and the operation pattern sent to the simulator program by the test control unit.

2. The program test device of claim 1, further comprising:
a test information storage unit that stores therein two or more test information; and
an automatic test unit that reads out two or more test information from the test information storage unit in sequence and sends the test information to the test information receiving unit.

3. The program test device of claim 2, wherein the test information includes correct answer information indicating a normal operation result of the test target program, and
the program test device further comprises:
a test result determination unit that acquires an operation result of the test target program executed by the executing unit, determines normality or abnormality by using the acquired operation result and the correct answer information included in the test information, and outputs a determination result.

4. The program test device of claim 1, wherein the test information includes an IO value to be used for an operation of the simulator program,
the test control unit acquires the operation pattern and the IO value included in the test information and sends the acquired operation pattern and the IO value to the simulator program, and
the executing unit sends the input information included in the test information to the test target program and executes the test target program, and also executes the simulator program by using the program information as an execution result of the test target program as well as the operation pattern and the IO value sent to the simulator program by the test control unit.

5. The program test device of claim 1, wherein the test control unit performs a process of acquiring the IO value as an operation result of the simulator program and outputting the IO value.

6. The program test device of claim 1, wherein the operation pattern includes at least a normal pattern and an abnormal pattern.

7. A program test device comprising:
a test target program storage unit that stores therein a test target program for controlling hardware;
a simulator program storage unit that stores therein a simulator program for simulating a hardware error operation;
a test information receiving unit that receives test information including an operation pattern and input information to be sent to the test target program so as to test the test target program;
a test control unit that acquires the operation pattern included in the test information; and
an executing unit that sends the input information included in the test information to the test target program and executes the test target program, sends program information as an execution result of the test target program to the hardware to thereby operate the hardware if the operation pattern acquired by the test control unit is a normal pattern, and executes the simulator program by using the program information as the execution result of the test target program if the operation pattern acquired by the test control unit is not a normal pattern.

8. The program test device of claim 7, further comprising:
a test information storage unit that stores therein two or more test information; and
an automatic test unit that reads out two or more test information from the test information storage unit in sequence and sends the test information to the test information receiving unit.

9. The program test device of claim 8, wherein the test information includes correct answer information indicating a normal operation result of the test target program, and
the program test device further comprises:
a test result determination unit that acquires an operation result of the test target program executed by the executing unit, determines normality or abnormality by using the acquired operation result and the correct answer information included in the test information, and outputs a determination result.

10. A program for allowing a computer to function as:
a test information receiving unit that receives test information including an operation pattern and input information to be sent to a test target program so as to test the test target program;
a test control unit that acquires the operation pattern included in the test information and sends the acquired operation pattern to a simulator program for simulating an operation of hardware; and
an executing unit that sends the input information included in the test information to the test target program and executes the test target program, and also executes the simulator program by using the program information as an execution result of the test target program and the operation pattern sent to the simulator program by the test control unit.

11. The program of claim 10, wherein the test information includes an IO value to be used for an operation of the simulator program,
the test control unit acquires the operation pattern and the IO value included in the test information and sends the acquired operation pattern and the IO value to the simulator program, and
the executing unit sends the input information included in the test information to the test target program and executes the test target program, and also executes the simulator program by using the program information as an execution result of the test target program as well as the operation pattern and the IO value sent to the simulator program by the test control unit.

12. The program of claim 10, wherein the test control unit also performs a process of acquiring the IO value as an operation result of the simulator program and outputting the IO value.

13. A program for allowing a computer to function as:
a test information receiving unit that receives test information including an operation information and input information to be sent to a test target program so as to test the test target program;
a test control unit that acquires the operation pattern included in the test information; and
an executing unit that sends the input information included in the test information to the test target program and executes the test target program, sends program information as an execution result of the test target program to the hardware to thereby operate the hardware if the operation pattern acquired by the test control unit is a normal pattern, and executes the simulator program by using the program information as the execution result of the test target program if the operation pattern acquired by the test control unit is not a normal pattern.
